(19) United States
(12) Patent Application Publication
(10) Pub. No.: US 2004/0027595 A1
(43) Pub. Date: Feb. 12, 2004

(54) Printing process

(76) Inventor: Thomas Senn, Dielsdorf (CH)

Correspondence Address: CUMMINGS & LOCKWOOD, Four Stamford Plaza, P.O. Box 120, Stamford, CT, 06904-0120, US

(21) Appl. No.: 10/634,367

(22) Filed: Aug. 5, 2003

(30) Foreign Application Priority Data
Aug. 5, 2002 (EP) 02016994.2

(51) Int. Cl. H04N 1/60; G06F 15/00; H04N 1/50

(52) U.S. Cl. 358/1.9; 358/504; 358/1.15; 358/518

(57) ABSTRACT

In an edition printing process, digital master image data are provided in a pre-printing stage, digital printing data are produced from the master image data, measurement positions and nominal color values in those measurement positions are determined, and the digital printing data as well as the measurement positions and nominal color values are transmitted to the print shop through a data channel. Printing plates are produced in the print shop on the basis of the digital printing data and the edition printing carried out in a printing machine by way of the printing plates. Test image data are thereby produced by image wise colorimetric measurement of one or more edition printing specimens by way of a preferably spectral color measurement system, and used for the color control of the printing machine together with the nominal color values. The test image data produced in the print shop are transmitted through a data channel to the pre-printing stage and there evaluated for quality control. A test image is especially formed from the test image data, displayed on a screen, and visually compared with a quality binding reference image. The result of the quality monitoring (printing release, color corrections) is transmitted through the data channel from the pre-printing stage to the print shop where it is used for the release of the edition printing or the influencing of the printing process.

### FIELD OF THE INVENTION

The invention relates to printing processes and in particular to quality monitoring and production release during edition printing.

### BACKGROUND OF THE INVENTION

The typical workflow of a print order is these days normally divided into two groups of processing steps. The first group generally occurs in the reprography unit and is referred to as the so-called pre-printing stage. Various preparatory process steps are carried out. The second group of process steps takes place in the print shop, whereby the edition printing is carried out. The pre-printing stage and the print shop are typically at separate locations.

The individual process steps in the pre-printing stage and the print shop are typically as follows:

First, an original in electronic form which is to be reproduced in the printing process is produced. Any image type can serve as original; the images are captured with an electronic camera or a film camera. Alternatively, a positive or a negative film or a plan view picture is captured by way of a color image scanner. As a result, the original is available in the form of digital original image data.

These image data are typically RGB encoded, which means a proper (digital) intensity signal exists for each image pixel for the three base colors red, green and blue. Alternatively, the image data can also be converted into an apparatus independent, standardized CIE-L*a*b* or CIE-X-Y-Z signal. These image data are generally processed by the reprographer according to different aspects and by way of a suitable image processing software.

CMYK printing data are calculated from the, possibly processed, image data. The paper and print color spectra and the color values derived therefrom are thereby used, or the CMYK printing data are taken from conversion tables. These printing data describe the surface coverage of the printing grid for the standard printing colors cyan (C), magenta (M), Yellow (Y), and black (K) in function of the image data. However, surface coverages for additional or other printing colors, for example special colors for packaging printing, can also be determined. Depending on the reproduction process, such as for example gravure printing or other printing processes, printing data, apart from surface coverage, can also reflect color amount or color intensity.

In the traditional printing process processing, the grid films are also generated from the CMYK printing data in the pre-printing stage, test print plates are produced and the so-called trial prints produced therewith by way of a special printing machine, the so-called trial printing machine. By way of a visual quality control of these trial prints, the responsible persons in the pre-printing stage or even the customer himself issues the “ok for printing”. The grid films are then transported together with the test print to the print shop, where the printing plates for the edition printing machine are made from the grid films and the edition printing is carried out therewith.

Apart from the above described technique of the trial prints, other test print methods are also used for quality control in the pre-printing stage. Special proof printers are used. They are controlled by CMYK-proof-data. These CMYK-proof-data are preferably derived from the CMYK-printing data, whereby the specific printing properties of the printing machine and printing colors used for the order can be taken into consideration. The proof printer displays the printing result to be expected (for example by use of ICC-profiles, with the help of which the printing process on the proof printer is determined). This test print is visually evaluated and serves as a basis for the “ok for print”.

Alternative to a test print, the printing image to be expected can also be evaluated on a screen (“soft proof”). The CMYK printing data are thereby converted into screen data and displayed on a screen. The paper and printing color spectra or color values serve as a basis therefor, or the screen data are taken from conversion tables which correspond to the order-specific printing conditions. The visual quality control then occurs on the screen. The comparison can also be carried out with the starting original. The “ok for printing” is then issued on the basis of this screen display.

In today's modern printing process processing, especially where large printing editions must be realized as quickly as possible, such as for example in the newspaper and magazine printing, the CMYK printing data are transferred through electronic communication channels directly to the print shop, or the same order is even transferred to several print shops. This can occur globally and over large distances. The printing data are then received in a print shop, the grid films are produced therefrom and the printing plates are exposed with the help thereof, or the printing plate exposure is preferably directly controlled with the CMYK printing data.

The printing plates are developed in the print shop and then mounted in the printing machine to start the edition printing.

After the start of the edition printing, the first printing examples are visually compared with the test print delivered by the pre-printing stage and the “ok for printing” issued upon acceptance. This release is carried out by the responsible person in the print shop, except if at that point in time a responsible person from the pre-printing stage or even the customer himself is present at the print shop.

Modern printing machines are generally equipped with a color measurement system. So called “online color measurement systems” are integrated into the printing machine and allow the color measurement at the running web of sheet and web printing machines. “Offline color measurement systems” are used especially together with sheet printing machines. In these color measurement systems, the printed test sheet is placed by the user onto the measurement system for the capture of measurement data and the printed image.

Measurement systems are also used which not only test selected measurement positions, but divide the whole printed sheet into a multitude of evenly distributed measurement elements which are all spectrally measured (for example U.S. Pat. No. 6,012,390). This technique also enables an image like reproduction of the spectral image measurement data on a screen. Special electronic cameras equipped for the colorimetric measurement can also be used (for example EP-A 1 213 568 and EP-A 1 213 56). They sequentially photograph the printed sheet divided into individual partial images. However, compared to the R-G-B-cameras used for the image capture, the local image resolution of these color measurement systems can be reduced. Systems with only 3 spectral ranges can be used apart from the spectrally measured image capture. The color data obtained therewith are then however limited in their absolute precision.

Specially selected image positions can also be defined as measurement elements and provided with calorimetric nominal data. This can already occur in the pre-printing stage and those nominal data as well as the measurement positions can be added to the CMYK image data for data transfer together. The nominal data are then compared with the measured actual data and upon color deviations which are too large, the color control units of the printing machine are automatically engaged.

The person operating the printing machine can also manually influence the coloration (color concentration or color layer thickness) of the printing machine and select the best compromise for the colored reproduction of all image motives. It is important in that case that the intended color correction can be reproduced in true color on the screen. In order that the intended color correction can be exactly determined ahead of time in the color measurement system by way of a printing process model, the preferably spectral data of the printing colors involved must be known.

As soon as the color errors are within acceptable limits and the color correspondence with the test print or the screen data is sufficient, the quality controllers in the print shop issue the “ok for offset printing”. The color measurement and the color control are in effect for the whole edition printing and the quality data are continuously recorded in an edition protocol.

In the above described quality control approaches, the problem exists that the edition printing release can only be carried out by the responsible persons in the print shop, except if at this point in time a responsible person from the pre-printing stage or the customer himself are present at the print shop. This is especially problematic when the pre-printing stage and the print shop are located far apart or when the same print order is printed simultaneously in several print shops, which is especially often the case with newspaper and magazine printing, whereby, for example the same newspaper edition is printed even simultaneously on different continents. It must further be considered that the original image because of the limited color space of each color reproduction process cannot always be printed true to color and that an optimal compromise for all image motives must be found. This compromise is subjective, since, for example, for a clothing magazine the clothing color is important and not the color of the car standing to the side, whereas the exact opposite is true for a car magazine. That means that the printing expert is not always in a position to reach the compromise optimal in the eye of the customer, so that the presence of the customer would be advantageous.

### SUMMARY OF THE INVENTION

It is an object of the present invention to optimize the color reproduction and improve a printing process preferably in such a way that the release for the edition printing, or more generally the monitoring and control of the printing quality of the edition printing, can be carried out directly from the location of the pre-printing stage or the customer and, if desired, can also be documented from there.

The advantages to be achieved according to the invention are based on a printing process in which, in a pre-printing stage,

digital original image data are provided which represent an original master,

digital printing data for the printing colors involved in the printing are produced from the master image data and

the digital printing data are transmitted to a print shop by way of a data channel and in which process in the print shop additionally

printing plates are produced by way of the digital printing data

and the edition printing is carried out in a printing machine by way of these printing plates,

whereby test image data representing a test image are produced by image wise colorimetric measurement of one or more edition printing specimen by way of a color measurement system

and used for the color control of the printing machine,

characterized in that,

the test image data produced in the print shop are transmitted to the pre-printing stage through a data channel,

that the test image data are evaluated in the pre-printing stage for quality monitoring,

that the result of the quality monitoring is transmitted to the print shop through a data channel,

and that in the print shop the result of the quality monitoring transmitted from the pre-printing stage is used for the release of the edition printing or for the control of the printing process.

The term pre-printing stage within the framework of the present invention includes any process step prior to the edition printing which is carried out at a location remote from the print shop carrying out the edition printing. The pre-printing stage also includes the customer, or the process steps which possibly are carried out at his location.

According to the most general object of the invention, the color and image data of edition printing specimens captured with a color measurement system in the print shop are thus transferred through a data channel to the pre-printing stage, where they are used for the monitoring and control of color deviations and preferably also for visual representation on a screen for the visual comparison with a reference image. On the basis of these data and comparisons, the release of the edition printing can be carried out directly from the pre-printing stage and, if desired, the print quality in the pre-printing stage can also be monitored, controlled and documented.

According to an especially advantageous aspect of the invention, the person responsible for control in the pre-printing stage can, analogously to the activity of the printing expert in the print shop, manually influence the coloration of the printing machine by presetting nominal color values, color layer thickness, color concentrations and nominal spectra or recipes of the printing colors participating in the print and by transfer of these data to the print shop, in order to achieve thereby the best compromise for the color representation of all image motifs.

On the basis of the pictoral representation of the test image data transmitted from the print shop, a visual comparison with the reference image is possible. The original master itself or a quality binding test or trial print can be used as the reference image. According to an especially advantageous preferred embodiment of the process in accordance with the invention, the reference image used is a screen representation either of the original master itself or of a quality binding test or trial print. This pictorial representation is preferably reproduced by way of an image scanning color measurement system, whereby preferably a color measurement system is used which is similar or identical to the one used in the print shop, in order to achieve an optimal correspondence between the reference and test data.

According to a further advantageous variant of the process in accordance with the invention, a so-called soft proof can be used as the reference image, which is calculated from the digital print data and reproduced on a screen.

### BRIEF DESCRIPTION OF THE DRAWINGS

The invention will now be further described in more detail by way of example only and with reference to the attached drawings, wherein

FIG. 1 is a block diagram of the steps carried out in the pre-printing stage in a first embodiment of the process in accordance with the invention;

FIG. 2 is a block diagram of the steps carried out in the print shop in the first exemplary embodiment of the process in accordance with the invention;

FIG. 3 is a block diagram of the steps carried out in the pre-printing stage in a second exemplary embodiment of the process in accordance with the invention;

FIG. 4 is a block diagram of the steps carried out in print shop in a further exemplary embodiment of the process in accordance with the invention.

### DETAILED DESCRIPTION OF THE PREFERRED EMBODIMENTS

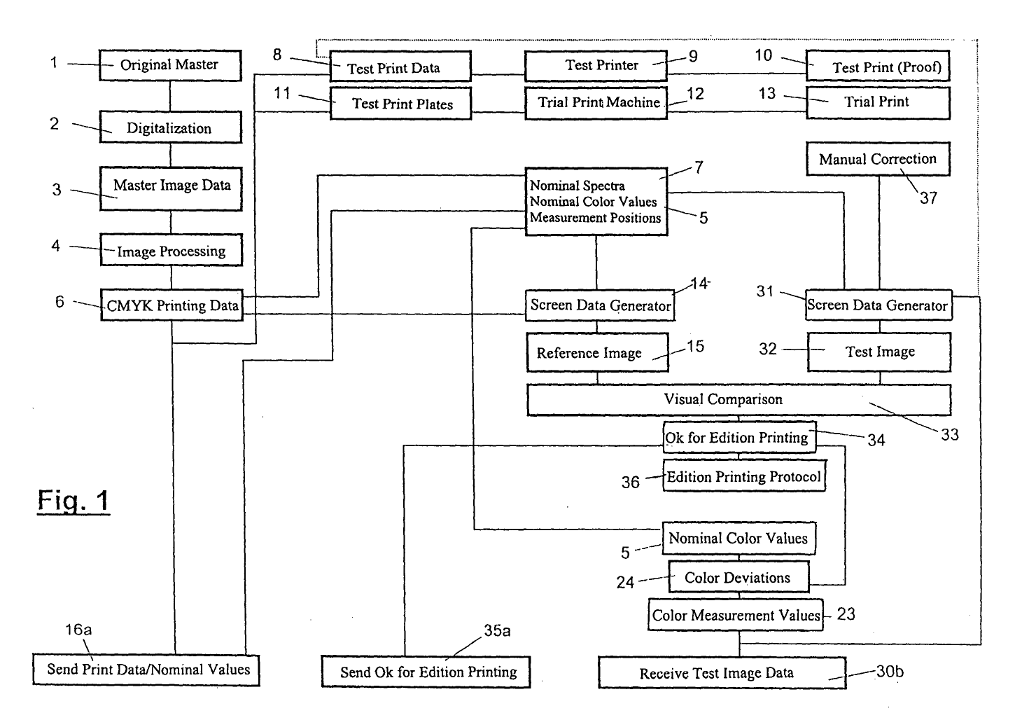

Digital master image data 3 are produced in the pre-printing stage (FIG. 1) from an original 1 to be reproduced by way of a digitalization unit 2. The specific construction of the digitalization unit 2 depends on the type of the original master and can be, for example, a color scanner or an electronic camera. If the original master is already present in the form of digital image data, the digitalization step is of course obviated.

The digital master image data 3 are processed many fold by way of an image processing program 4 until the desired color impression is achieved. Selected measurement positions and nominal color values 5 at those measurement positions can also be established at that opportunity, which can then be referred to later on in the print shop for the color control.

Subsequently, digital CMYK-print data 6 (grid color extracts) can be calculated as a function of the image data from the processed image data for the print colors involved in the printing. The calculation of the print data is carried out in a generally known manner by reference to the paper and print color spectra 7 which are available for this purpose in the pre-printing stage.

Test print data 8 are calculated from the CMYK-print data 6 in an also generally known manner and transferred to a test printer 9, which produces a test print (“proof”) 10 therefrom representing the edition printing result to be expected. The calculation of the test print data 8 from the CMYK-print data 6 is carried out in such a way that the specific print properties of the printing machine and printing colors used for the order in the print shop is taken into consideration. The test print 10 is visually evaluated and serves as the basis for the “ok for printing”.

As an alternative to the test print 10, grid film can be produced from the CMYK-printing data 6 and test print plates 11 can be made therefrom for a specific trial print machine 12 and several trial prints 13 produced with this trial print machine, which are then visually evaluated and analogously to the test print 10 used as the basis for the “ok to print”.

A further, especially practical variant for the first evaluation of the printing result to be expected consists in the production of a virtual test print on a screen. The CMYKprint data 6 are therefore recalculated in a generally known manner in an screen data generator 14 into corresponding screen data under consideration of the paper and print color spectra 7 and the print data are then reproduced on a screen as a so-called “soft proof” 15. This soft proof 15 can then on one hand again be used as the basis for the “ok to print” and on the other hand, as will be explained in detail further below, used as reference image for the quality evaluation in accordance with the invention of the edition printing.

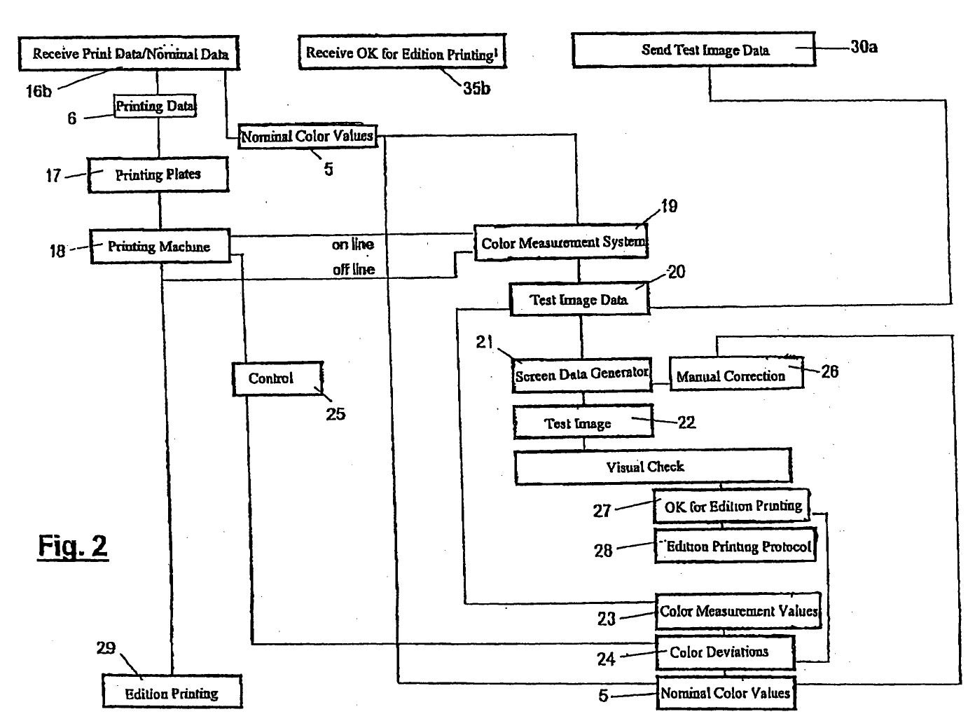

When the test print 10 or the trial print 13 or the soft proof 15 are satisfactory, the CMYK-printing data 6 and the measurement positions and nominal color values 5 are transmitted through a data channel 16a-16b to the print shop. In the print shop (FIG. 2), printing plates 17 for the printing machine 18 used are produced from the received CMYK-printing data 6 in a generally known manner and several edition print specimens are subsequently printed.

The printing machine 18 is provided with a color measurement system 19 operating on-line or off-line, by which the whole printed sheet can be image wise scanned and measured. A suitable color measurement system is described, for example in U.S. Pat. No. 6,012,390. The color measurement system 19 is preferably spectrally designed and produces for each measured image element (pixel) a number of remission values at different wavelengths. Typically, sixteen wavelength ranges with respective mean spacings of twenty nanometers are measured over a total spectral range of 400 nm-700 nm. The totality of the data produced by the color measurement system 19 for a completely measured printed sheet is referred to as test image data 20. The test image data can also originate from several measured edition print specimen.

The test image data 20 are recalculated into corresponding screen data by way of a screen data generator 21 and displayed as test image 22 on a screen. The test image 22, which means the screen representation of an edition print specimen captured by the color measurement system 19, can be used for the visual quality assessment.

The test image data 20 include especially also the actual color measurement value 23 at the measurement position pre-selected in the pre-printing stage. The actual color measurement values 23 are compared with the nominal color values 5 transmitted from the pre-printing stage and color deviations 24 are formed therefrom. The color deviations 24 at the individual measurement positions are transmitted to the color control system 25 of the printing machine 18 and evaluated thereby for the automatic control of the coloring.

The screen data generator 21 includes also a model of the printing process, which means the printing properties of the printing machine 18 in connection with the printing colors and paper qualities used. This allows the printing expert to visualize in true color the effects of the manual corrections 26 in the test image 22 before their translation in the printing machine.

As soon as the color deviations 24 are within acceptable limits, the “ok for edition printing” 27 can be issued by the quality controller in the print shop. The color measurement 19 and color control 25 are effective throughout the whole edition printing 29 and quality data can be continuously registered in an edition protocol 28.

To this point, the printing process in accordance with the invention corresponds to the prior art so that the person skilled in the art does not need any further explanation.

According to the invention, the printing process further includes the steps of transmitting the test image data 20 produced in the print shop by the color measurement system 19 through a data channel 30a-30b to the pre-printing stage immediately after commencement of the edition printing (FIG. 1). This is carried out analogous the transfer of the CMYK-printing data 6, but in opposite direction. The test image data received in the pre-printing stage can now be evaluated for the quality monitoring in the pre-printing stage in the same manner as traditionally in the print shop.

First, the test image data 20 are fed to a screen data generator 31, which, the same as the screen data generator 21 in the print shop, recalculates the test image data 20 into a test image 32 and reproduces them on a screen. This test image 32, which means the screen image of an edition print specimen 29 measured in the print shop, is subjected in the pre-printing stage by the quality controller to a visual comparison 33 with the quality binding reference image 15, whereby this visual comparison serves as the basis for the “ok for edition printing” 34. Upon a satisfactory comparison result, the release for the edition printing is then transmitted to the print shop through a data channel 35a-35b and the productive edition printing is then started or continued in the print shop.

It is readily understood that the data channel 16a-16b, 30a-30b and 35a-35b can also be realized in practice by a single data channel.

The actual color measurement values 23 at the pre-selected measurement positions included in the test image data 20 are compared with corresponding nominal color values 5 and color deviations 24 formed therefrom. The latter can on the one hand form the basis for the “ok for edition printing” 34 and on the other hand also for the continuous documentation 36 of the quality of the edition printing in the pre-printing stage.

Either the original master 1 itself or a quality binding test print 10 or trial print 13 can be used as reference image in the pre-printing stage. In the specific embodiment, the virtual test print (“soft proof”) 15 is used as the reference image. It is readily understood that the reference image and a test image need not necessarily be displayed on two separate screens, but can also be simultaneously or alternatingly displayed on a single monitor.

Analogous to the image data generator 21 in the print shop, the screen data generator 31 includes a model of the edition printing process so that analogous to the activity of the printing expert in the print shop, manual corrections 37 of the coloration (color layer thicknesses, color concentration) can be carried out already in the pre-printing stage and their effect on the print can be represented in true color on the screen. The corrections can also possibly be illustrated on the screen simultaneous to the uncorrected test image in that the image is, for example, divided in a checkered manner and the unchanged image information illustrated in the uneven fields, while the corrected image information is illustrated in the even fields.

The nominal color values 5 in the pre-selected measurement positions are generally changed on the basis of the manual corrections in the pre-printing stage carried out on the basis of the desired color change. However, the recipes (nominal spectra) of the print colors involved can also be reestablished. This is especially advantageous for so-called special colors as are used, for example, in the printing of packaging.

The changed nominal color values 5 and possibly nominal spectra 7 are then again transmitted to the print shop through the data channel 16a-16b. New color deviations 24 are generated there, which automatically act on the color guide elements of the printing machine 18 by way of the color control 25.

In extreme cases, one can also directly influence the image processing 4 in the pre-printing stage on the basis of the desired color change. New or changed CMYK-printing data 6 are thereby generated, which are also transmitted to the print shop and there used for the production of new printing plates 17. This can be practically realized especially when the printing machine is equipped for the so called DDTP-Technology (“direct digital to press”), which means the printing plate exposure directly in the printing machine is possible.

Several edition print specimen are then again printed in the print shop, measured by way of the color measurement system 19 and the test image data 20 captured thereby transmitted to the pre-printing stage.

As soon as the color deviations 24 in the pre-printing stage are within acceptable limits and the color correspondence between the test image 32 and the reference image 15 (or the original 1 or the test print 10 or the trial print 13) is sufficient, the release for the edition printing occurs directly from the pre-printing stage and the “ok for edition printing” 34 is transmitted in the already described manner directly to the print shop.

The transmission of the test image data 20 can be active during the whole edition printing and the quality data (for example color deviations 24) can be continuously registered in an edition printing protocol 36.

Alternatively or additionally to the representation of the test image 32 on a screen, CMYK-test-trial print data can be calculated from the test image data 20, which are printed out with the already mentioned trial printer 9. This printout can then be visually compared with the previously printed test print 10, which was derived from the CMYK-printing data 6.

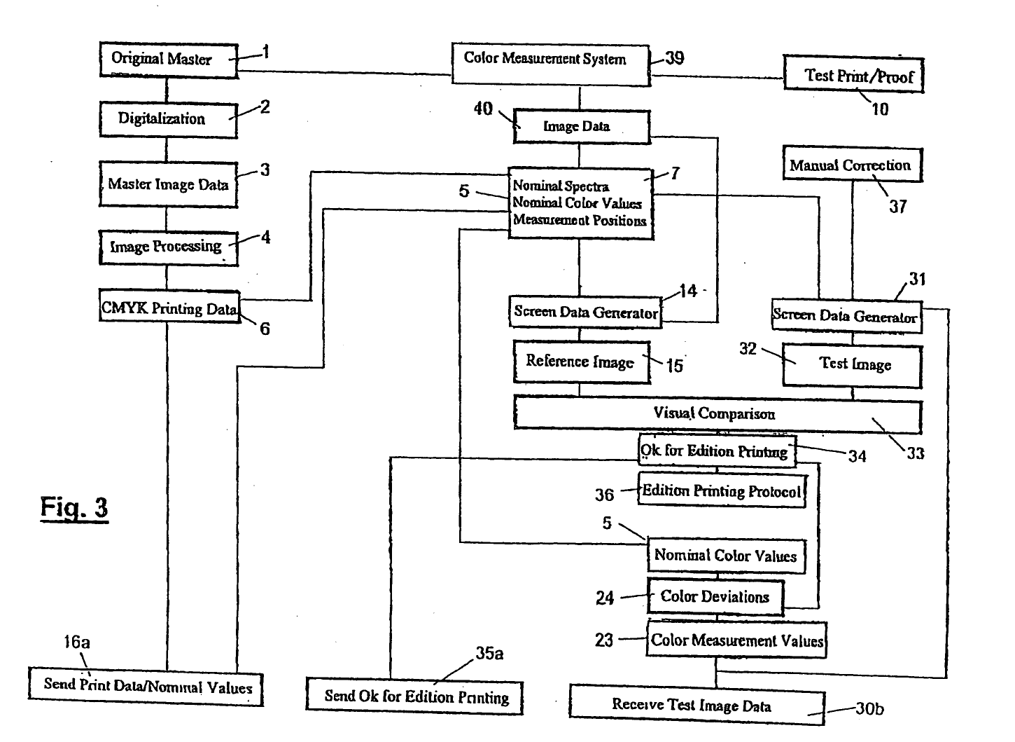

According to FIG. 3, the pre-printing stage can also be equipped with a (preferably spectral) color measurement system 39. The original master 1, as long as it consists of a photographic print, can be image wise calorimetrically measured, whereby image data 40 result. These image data are recalculated in the screen data generator 14 into corresponding screen data and then illustrated on the screen as a reference image 15 and used for the visual comparison with the test image 32 captured in the print shop. The advantage of the measurement of the original master 1 with a color measurement system compared to the capture with a reprography camera (digitalization 2) resides in the exact colorimetric image capture. The color measurement systems 19 and 39 in the print shop or the pre-printing stage are preferably of the same construction, whereby optimal correspondence between the test image data and the reference image data is guaranteed.

Not every original image master can be directly captured with the color measurement system 39. In that situation, the test print 10 produced with the test printer 9 or the trial print 13 produced with the trial print machine 12 can be agreed on as quality reference between the customer and the pre-printing stage. The test or trial print can then be captured with a color measurement system 39 and its data compared also with the test image data of an edition specimen, which was captured with a color measurement system 19 in the print shop. The color measurement systems 19 and 39 in the print shop and the pre-printing stage can also be preferably equipped with a goniometric measurement geometry which allows an illumination not only, as is customary, at an angle of 45 degrees to the recording direction, but in several, different directions. The visual impression from different observation directions can thereby be reproduced and especially the gloss of different picture surfaces evaluated.

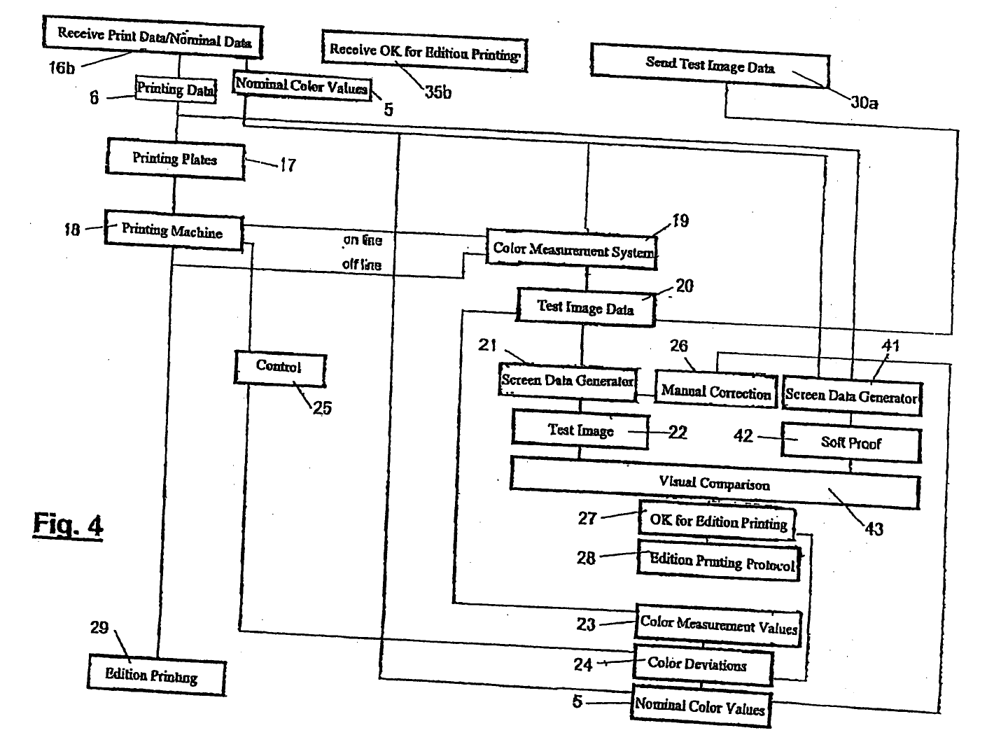

As illustrated in FIG. 4, additionally or alternatively to the quality monitoring in the pre-printing stage, a virtual test print (“soft proof”) 42 can be calculated also in the print shop from the digital print data 6 transmitted from the pre-printing stage by way of a further screen data generator 41 and reproduced on a screen. This virtual test print 42 can then be used for the visual comparison with the test image 22 captured there, or directly with an edition print specimen 29 and can form the basis for the release for the edition printing.

1. Printing process with a pre-printing printing stage in which digital master image data are provided which represent an original master, digital printing data for the printing colors involved in the printing are produced from the master image data and the digital printing data are transmitted to a print shop by way of a data channel for production in the print shop of printing plates by way of the digital printing data, and an edition printing stage in which edition printing is carried out by way of these printing plates in a printing machine, comprising the steps of producing test image data representing a test image by image wise colorimetric measurement of one or more edition printing specimen by way of a color measurement;
transmitting the test image data produced in the print shop to the pre-printing stage through a data channel,
evaluating the test image data in the pre-printing stage for quality monitoring,
transmitting a result of the quality monitoring to the print shop through a data channel; and
using in the print shop the result of the quality monitoring transmitted from the pre-printing stage for at least one of the release of the edition printing and the control of the printing process.

2. Process according to claim 1, wherein in the pre-printing stage measurement positions and nominal color values at these measurement positions are determined and transmitted through the data channel to the print shop, whereby the nominal color values are used in the print shop for the color control of the printing machine.

3. Process according to claim 1, wherein a spectrally operating color measurement system is used for the image wise colorimetric measurement of the edition printing specimen and wherein the test image data transmitted to the pre-printing stage are spectral data which include for each measured image point remission values for several, different wave lengths.

4. Process according to claim 3, wherein the wave lengths are 16 wave lengths in the range of 400 to 700 nm with a respective spacing of 20 nm.

5. Process according to claim 1, wherein a test image is calculated on the basis of the test image data transferred to the pre-printing stage and visually displayed on a screen and wherein the quality monitoring includes a visual comparison of the displayed test image with a reference image.

6. Process according to claim 1, wherein the quality monitoring includes a monitoring of color deviations between the nominal color values and the corresponding color measurement values contained in the test image data.

7. Process according to claim 1, wherein digital test print data are produced from the test image data transferred to the pre-printing stage, a physical test print is produced by way of these digital test print data, and the quality monitoring includes a visual comparison of this test print with a reference image.

8. Process according to claim 7, wherein the reference image is a test print or trial print produced in the pre-printing stage by way of the digital printing data.

9. Process according to claim 1, wherein the release for the edition printing is transmitted to the print shop as a result of the quality monitoring in the pre-printing stage.

10. Process according to claim 1, wherein as a result of the quality monitoring in the pre-printing stage because of a desired color change new or modified nominal color values are transmitted to the print shop.

11. Process according to claim 1, wherein as a result of the quality monitoring in the pre-printing stage because of a desired color change new or modified layer thickness values or concentration values for the colors involved in the printing are transmitted to the print shop.

12. Process according to claim 1, wherein as a result of the quality monitoring in the pre-printing stage because of a desired color change new or modified nominal spectra or recipes for the colors involved in the printing are transmitted to the print shop.

13. Process according to claim 1, wherein as a result of the quality monitoring in the pre-printing stage because of a desired color change new or modified digital printing data are produced and transmitted to the print shop for the production of new printing plates in the print shop on the basis of the digital print data, and use of the printing plates for the edition printing.

14. Process according to claim 1, wherein the quality monitoring in the pre-printing stage includes a protocolling of the print quality of the edition printing.

15. Process according to claim 1, wherein the original master or a screen display thereof is used as reference image for the visual comparison with the test image.

16. Process according to claim 1, wherein a test print or trial print printed by way of the digital printing data and binding for the quality, or a screen display thereof, is used as reference image for the visual comparison with the test image.

17. Process according to claim 1, wherein a screen display of a virtual test print calculated from the digital printing data and binding for the quality is used as reference image for the visual comparison with the test image.

18. Process according to claim 1, wherein a virtual test print is calculated in the print shop from the digital printing data transmitted from the pre-printing stage and displayed on a screen, and wherein this virtual test print is used for the visual comparison with the test image captured in the print shop or directly with a trial print specimen.

19. Process according to claim 1, wherein in the pre-printing stage the original master or a test print binding for the quality is image wise measured by way of a preferably spectral color measurement system, a screen display of the original master or the test print is produced from the image data obtained thereby, and the screen display is used as a reference image for the comparison with the test image.

20. Process according to claim 1, wherein the color measurement system of the print shop and the color measurement system in the pre-printing stage are equipped with a goniometric measurement geometry which allows illumination in different directions for the image capture.
